(19) United States
(12) Patent Application Publication
(10) Pub. No.: US 2011/0284729 A1
(43) Pub. Date: Nov. 24, 2011

(54) Systems and Methods for Harvesting Optical Energy

(75) Inventors: Ayman Abouraddy, Oviedo, FL (US); Robert Bernath, Orlando, FL (US); Esmaeil Banaei, Orlando, FL (US)

(73) Assignee: University of Central Florida Research Foundation, Inc., Orlando, FL (US)

(21) Appl. No.: 13/105,587

(22) Filed: May 11, 2011

Related U.S. Application Data
(60) Provisional application No. 61/333,469, filed on May 11, 2010.

(51) Int. Cl. G01J 1/04; G02F 1/35

(52) U.S. Cl. 250/227.11; 359/326

(57) ABSTRACT

In one embodiment a system and method for harvesting optical energy employ an optical energy harvesting fiber including a core having active elements that absorb light at one wavelength of range of wavelengths and emit light at one or more different wavelengths, a guiding structure that guides the emitted light along a length of the fiber, and a cladding that surrounds the core.

### CROSS-REFERENCE TO RELATED APPLICATION

This application claims priority to copending U.S. provisional application entitled, “Optical Energy-Harvesting Fibers and Fabrics,” having Ser. No. 61/333,469, filed May 11, 2010, which is entirely incorporated herein by reference.

### BACKGROUND

The energy in sunlight has been collected using a number of methods ranging from using photovoltaic cells (e.g., solar panels) to passing water through black tubing (e.g., on a roof) to heat swimming pools. Photovoltaic cells are used in a wide variety of applications ranging from battery charging of portable electronic devices to providing electrical power for satellites. Photovoltaic cells, however, have a response curve (of electrical energy output versus optical energy input) that is relatively narrow, and typically collect energy efficiently in only limited wavelength bands. For example, such cells typically collect energy efficiently in the blue-green through red part of the visible spectrum and near infrared, inefficiently collect the blue and violet part of the visible spectrum, and collect very little ultraviolet light. While the solar spectrum varies with altitude, humidity, cloudiness, and time of day, the portion of the solar spectrum to which a photovoltaic cell responds generally contains less than one third of the energy in the solar spectrum. In addition, photovoltaic cells are relatively heavy, expensive, and inflexible.

It can therefore be appreciated that it would be desirable to have a new system and method for harvesting optical energy, such as solar energy.

### BRIEF DESCRIPTION OF THE DRAWINGS

The present disclosure may be better understood with reference to the following figures. Matching reference numerals designate corresponding parts throughout the figures, which are not necessarily drawn to scale.

FIG. 1A is an end view of a first embodiment of an optical energy harvesting fiber illustrating optical energy entering the fiber.

FIG. 1B is a side view of the optical energy harvesting fiber of FIG. 1A, illustrating the fiber delivering the optical energy along the length of the fiber.

FIG. 2 is an end view of a second embodiment of an optical energy harvesting fiber.

FIG. 4 is an end view of a third embodiment of an optical energy harvesting fiber.

FIG. 5 is an end view of a fourth embodiment of an optical energy harvesting fiber.

FIGS. 6A-6F are perspective views of various embodiments of the cladding of an optical energy harvesting fiber.

FIGS. 7A-7C are side views of embodiments of ramp structures provided in a cladding of an optical energy harvesting fiber.

FIGS. 8A and 8B are end and side views, respectively, of a first embodiment of an optical energy harvesting fiber that comprises a coupling grating within its cladding.

FIGS. 9A and 9B are end and side views, respectively, of a second embodiment of an optical energy harvesting fiber that comprises a coupling grating within its cladding.

FIGS. 10A-10F are graphs, drawings, and images of embodiments of active elements that can be incorporated into an optical energy harvesting fiber.

FIG. 11 is a side view of a plurality of optical energy harvesting fibers coupled with photovoltaic cell assemblies.

FIG. 12 is a cross-sectional side view of a first embodiment of a fabric that incorporates optical energy harvesting fibers.

FIG. 13 is a cross-sectional side view of a second embodiment of a fabric that incorporates optical energy harvesting fibers.

### DETAILED DESCRIPTION

As described above, conventional photovoltaic cells (e.g., solar panels) exhibit various drawbacks. Disclosed herein are systems and methods for harvesting optical energy that avoid one or more of those drawbacks. As is described below, the systems and methods use optical energy harvesting fibers that collect incident external optical energy (e.g., solar energy) and deliver that energy along their lengths to one or more photovoltaic cells. In some embodiments, the optical energy harvesting fibers each comprise a core that includes active elements that absorb the incident optical energy and emit light at a particular wavelength or range of wavelengths, and a guiding structure that guides the emitted light along the length of the fiber so that the emitted light can be delivered to a photovoltaic cell coupled to the end of the fiber. In some embodiments, the guiding structure is specifically configured to reflect the wavelength or wavelengths of light emitted by the active elements and the photovoltaic cell is specifically optimized for the wavelength or wavelengths of light emitted by the active elements. The optical energy harvesting fibers can be used to form fabrics that harvest optical energy.

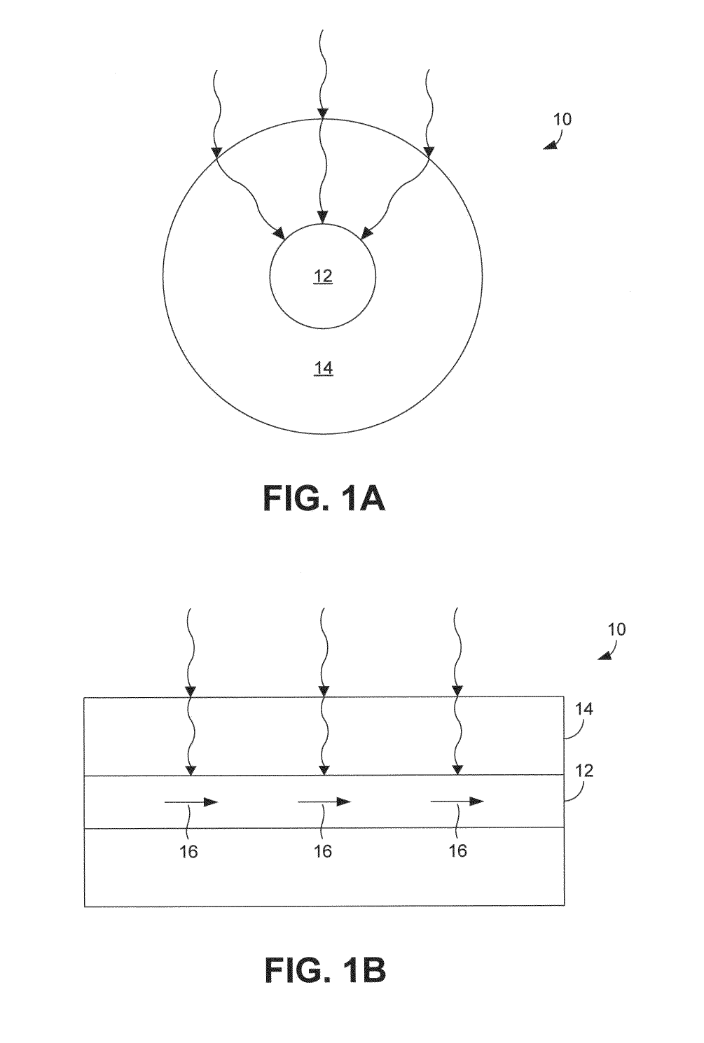

The general functionality of the disclosed optical energy harvesting fibers is illustrated in FIGS. 1A and 1B. Those figures show an embodiment of an optical energy harvesting fiber 10 that comprises an inner core 12 and an outer cladding 14. The fiber 10 captures external optical radiation (indicated by wavy lines) that is incident upon the outer surface of the cladding 14. The radiation travels through the cladding 14 and into the core 12 and then travels along the core, as indicated by arrows 16 in FIG. 1B, to one or both ends of the fiber 10. In some embodiments, the fiber 10 collects wideband optical radiation (e.g., solar light) and the core converts it into spectrally narrowband optical radiation. At least one end of the fiber 10 is optically connected to one or more small-area photovoltaic cells, which can be optimized for the generated wavelengths. When the photovoltaic cells are optimized for the generated wavelengths, the cells can operate with higher efficiency than a cell intended to absorb all wavelengths.

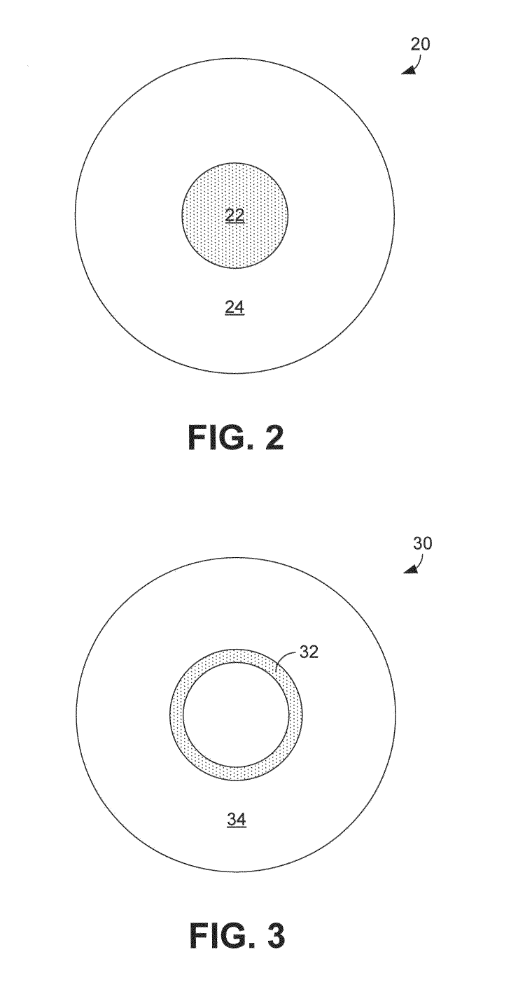

FIG. 2 illustrates a first example construction for an optical energy harvesting fiber 20. As is shown in FIG. 2, the fiber 20 comprises a solid inner core 22 that is surrounded by a cladding 24. In some embodiments, both the core 22 and the cladding 24 are made of a polymeric material. Regardless, the core 22 comprises active elements that absorb optical energy and emit light at one or more specific wavelengths. The active elements can comprise one or more of fluorescent dyes, phosphorous dyes, nanoparticles, and quantum dots. In embodiments in which the core 22 is a polymer core, the core can be doped with active element particles. In some embodiments, the active element particles are nano-crystalline phosphor particles.

In some embodiments, the active elements perform down conversion, meaning that they absorb relatively high energy light and emit relatively low energy light. Examples of sets of red, green, and blue emitting down-converting phosphors are described in U.S. Pat. No. 3,858,082, which is hereby incorporated by reference into this disclosure. As an example, the active elements can absorb green light having a wavelength in the range of approximately 495 to 570 nanometers (nm) and emit red light having a wavelength in the range of approximately 620 to 750 nm. Alternatively, the active elements perform up conversion, meaning that they absorb relatively lower energy light and emit relatively higher energy light. Because the goal is to capture and absorb as much of the incident light as possible, multiple different types of active elements can be provided in the core 22, each optimized to absorb light of different wavelength band but each configured to emit light at the same wavelength or wavelengths.

The fiber 20 inherently comprises a “guiding structure” that prevents the emitted light from escaping the core 22. In the embodiment of FIG. 2, the guiding structure comprises the core 22, which has a relatively high index of refraction, and the cladding 24, which has a relatively low index of refraction, so as to provide for total internal reflection within the core. In such a case, the majority of the emitted light will not leave the core 22 and will ultimately travel to the ends of the fiber 20. A photovoltaic cell can be provided at each end of the fiber 20, or a mirror can be provided at one end and a photovoltaic cell can be provided at the other end.

FIG. 3 illustrates a second example construction for an optical energy harvesting fiber 30. The fiber 30 comprises a hollow inner core 32 (air core) that is surrounded by a cladding 34. Like the core and cladding of the fiber 20, both the core 22 and the cladding 24 of the fiber 30 can be made of a polymeric material. Like the core 22, the core 32 also comprises active elements that absorb incident optical energy and emit light at one or more specific wavelengths. Like the fiber 20, the fiber 30 inherently comprises a guiding structure in the form of the core 32, which has a relatively high index of refraction, and the cladding 24, which has a relatively low index of refraction.

FIG. 4 illustrates a third example construction for an optical energy harvesting fiber 40. The fiber 40 comprises a solid inner core 42 that is surrounded by a guiding structure 44 and a cladding 46. Like the core and cladding of the fiber 20, both the core 42 and the cladding 46 of the fiber 40 can be made of a polymeric material. The core 42 comprises active elements that absorb incident optical energy and emit light at one or more specific wavelengths. In some embodiments, the cladding 46 can have a gradient index of refraction such that the index of refraction is highest near the outer surface of the cladding and gradually decreases toward the core 42.

The guiding structure 44, which can be embedded within the cladding 46, enables incident light to pass from the cladding and into the core 42 where it can be absorbed by the active elements but reflects the light that is emitted by the active elements so that it is trapped within the core. In some embodiments, the guiding structure 44 comprises a photonic bandgap (PBG) structure that comprises multiple PBG layers 48 that together act as a waveguide for light of the wavelength(s) emitted by the active elements. In some embodiments, the PBG layers 48 comprise alternating glass and polymer layers having large differences in index of refraction. By way of example, the PBG layers 48 can comprise approximately 10 to 30 pairs of alternating layers.

In some embodiments, the fiber 40 can be made by co-extruding a core 42 with a inner portion containing the active elements and a transparent outer portion, depositing PBG layers 48 on the transparent outer portion of the core, and depositing a transparent cladding 46 over the PBG layers.

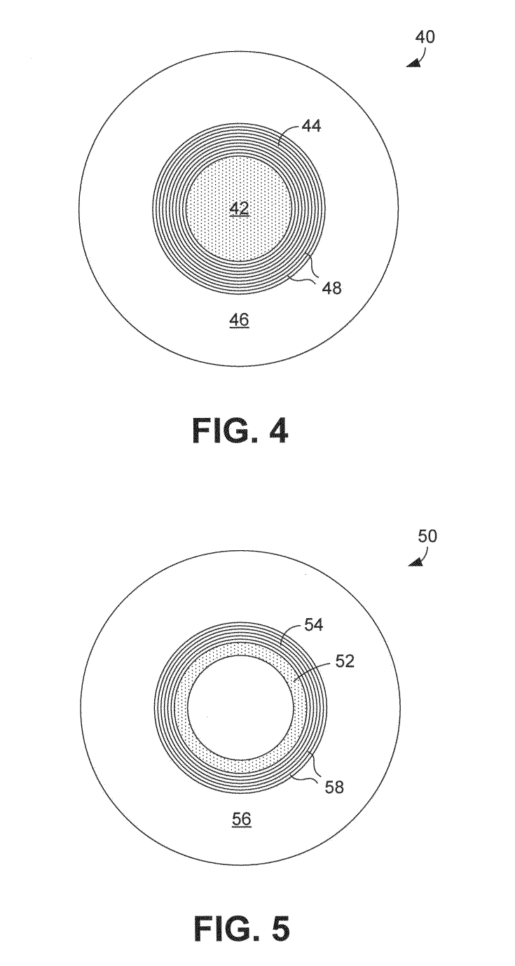

FIG. 5 illustrates a fifth example construction for an optical energy harvesting fiber 50. The fiber 50 is similar in many ways to the fiber 40 of FIG. 4. However, the fiber 50 comprises a hollow inner core 52 that is surrounded by a guiding structure 54 (including layers 58) and a cladding 56.

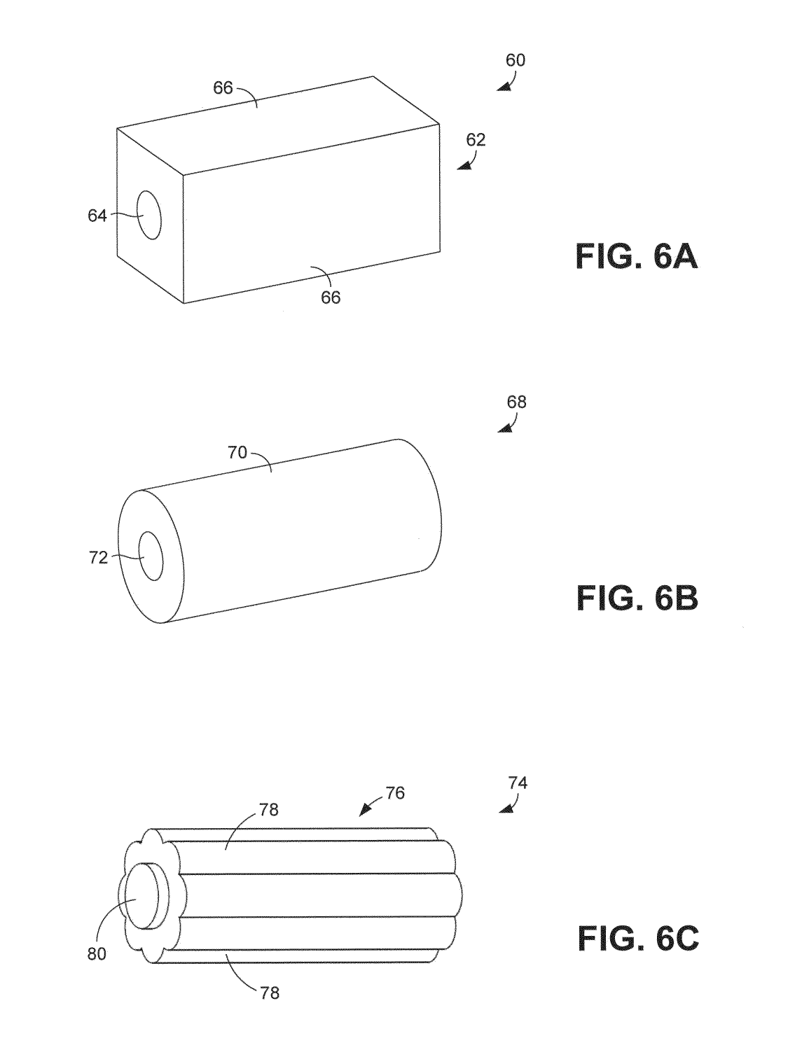

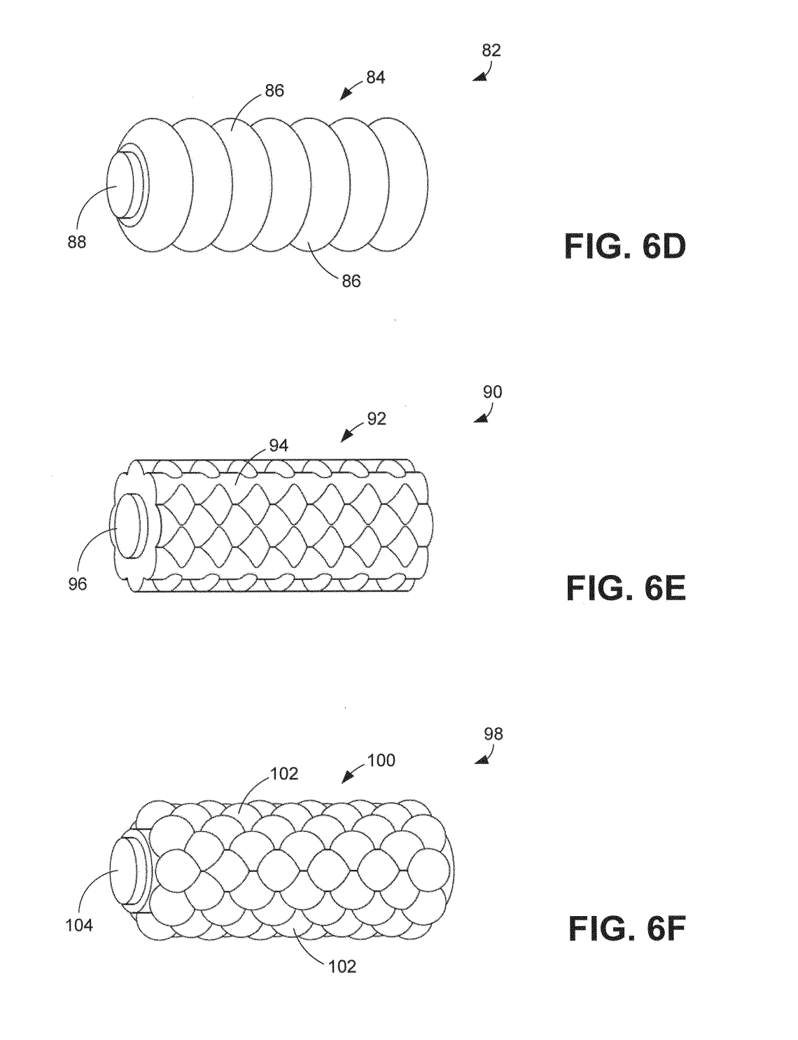

In some embodiments, the conversion efficiency in the fibers can be enhanced by altering the shape of the outer surface of the cladding. For example, imaging features can be created on the surface of the cladding to focus the incident light into the core, which contains the active elements. Such focusing can increase the localized fluence and can thereby increase the efficiency of the optical conversion. Several example embodiments of fiber claddings are illustrated in FIGS. 6A-6F.

Beginning with FIG. 6A, an optical energy harvesting fiber 60 is shown that has a rectangular cross section such that the cladding 62 that surrounds the core 64 includes four orthogonally-oriented planar surfaces 66. In FIG. 6B, an optical energy harvesting fiber 68 has a conventional cylindrical cladding 70 that surrounds a core 72. In FIG. 6C, an optical energy harvesting fiber 74 comprises a cladding 76 having a plurality of longitudinal lenslets 78 that extend along the length of the fiber and concentrate incident light into the fiber core 80. In FIG. 6D, an optical energy harvesting fiber 82 comprises a cladding 84 that includes a plurality of radial lenslets 86 that concentrate incident light into the fiber core 88. In FIG. 6E, an optical energy harvesting fiber 90 comprises a cladding 92 that includes a bidirectional lenslet array 94 that concentrates incident light into the fiber core 96. Finally, in FIG. 6F, an optical energy harvesting fiber 98 comprises a cladding 100 that has a bidirectional lenslet array 102 that concentrates incident light into a fiber core 104. Many other optical features can be incorporated into the cladding of the fiber and are not limited to the ones illustrated in FIGS. 6A-6F. Such features can be formed by embossing, extrusion, or any other suitable method.

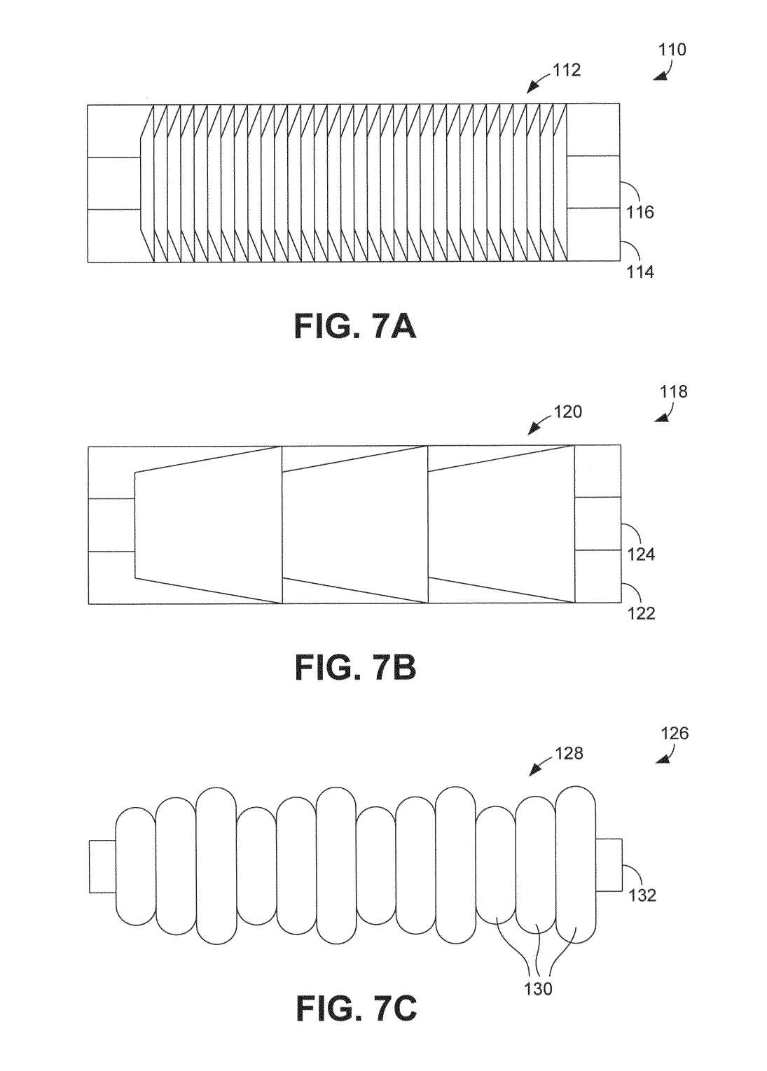

FIGS. 7A-7C illustrate possible embodiments for ramp structures that can be incorporated into the cladding of an optical energy harvesting fiber. FIG. 7A illustrates a fiber 110 that includes a steep ramp structure 112 provided within the cladding 114 that surrounds the fiber core 116. The ramp structure 112 guides incident light into and along the core 116. FIG. 7B illustrates a fiber 118 that includes a less steep ramp structure 120 provided within the cladding 122 that surrounds the fiber core 124. FIG. 7C illustrates a further fiber 126 comprising a cladding 128 having a hybrid ramp and a lenslet design in which sets of radial lenslets 130 of increasing diameter surround the core 132.

Coupling gratings can also be incorporated into the cladding of the optical energy harvesting fibers. Such gratings can be created, for example, by embossing a nano-structure on the plastic cladding as the fiber is first pulled through a dip coater, then through an annulus cutter, and into the embossing machine that produces a grating structure orthogonal to the length of the fiber. The fiber can then be placed into a second plastic dip coater containing plastic that has a different index of refraction than the embossed first layer. The coated fiber can then be drawn through a second annulus cutter to produce a slightly larger diameter fiber with an embedded coupling grating adjacent to the waveguiding PBG structure. This process can be repeated to create a compound stratified coupling grating that effectively couples broader regions of the electromagnetic spectra into the photonic bandgap waveguide structure.

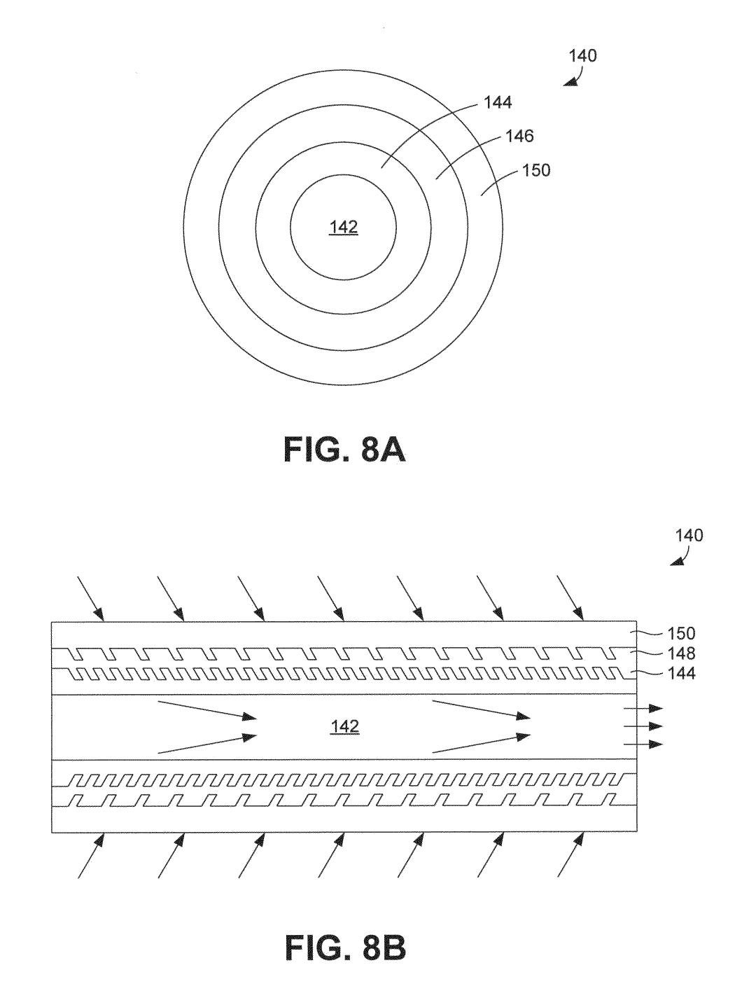

FIGS. 8A and 8B illustrate an example embodiment of an optical energy harvesting fiber 140 having gratings incorporated into its cladding. As is shown in those figures, the fiber 140 comprises a core 142 doped with active elements, a first coating layer 144 having a relatively high-frequency imprint grating, a second coating layer 146 having a relatively low-frequency imprint grating, and a protective coating 150. As is shown by the directional arrows in FIG. 8B, incident light is guided by the guiding structures into the core 142 and along its length.

In addition to embossing grating structures onto the fiber, the grating layers can be embossed on the thin laminates used to make the pre-form. These thin layers of plastic can be rolled onto the fiber pre-form before the top layers are added. When the pre-form is drawn, the patterns are at the designed size. It is also possible to extrude the pre-form with the grating structures already in place. The grating structure's size in the pre-form can be calculated to be the proper size after drawing.

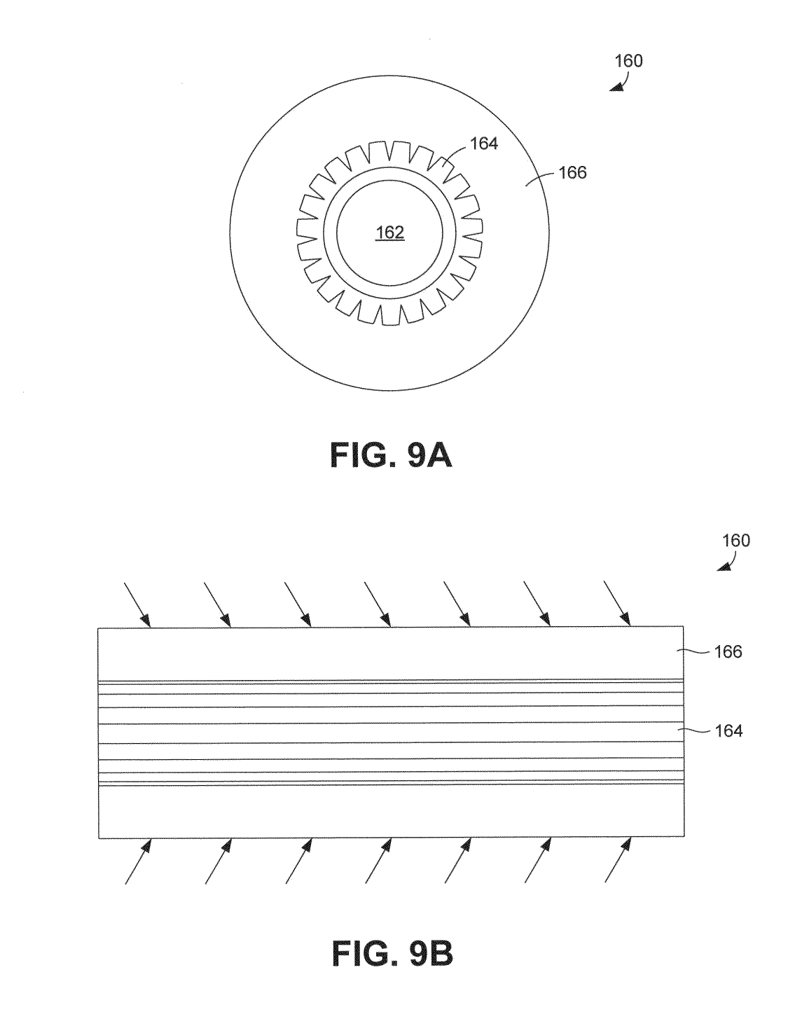

FIGS. 9A and 9B illustrate an example embodiment of an optical energy harvesting fiber 160 that incorporates radial and axial grating layers. As is shown in those figures, the fiber 160 comprises a core 162 doped with active elements, a longitudinal grating structure 164 that extends along the length of the fiber, and a protective coating 166.

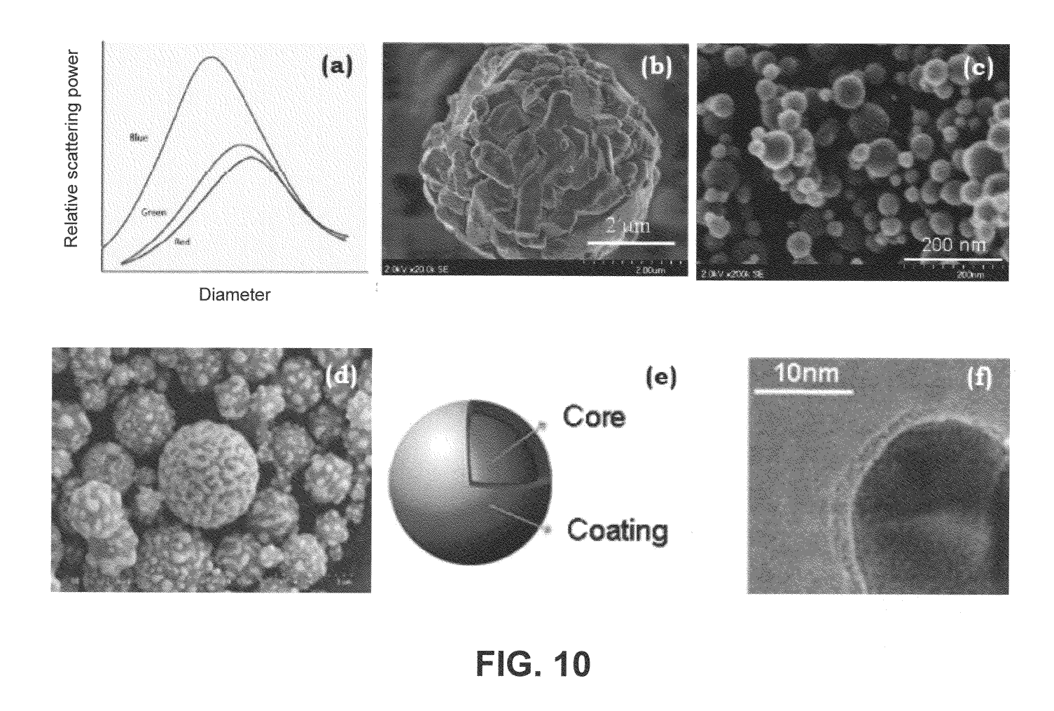

To reduce scattering, the active elements (e.g., luminescent particles) used in the cores of the optical energy harvesting fibers can have a size that is optimized based on the wavelength of light and refractive index of the material. Analysis of scattering curves indicates that the optimum particle sizes can be approximately less than 100 nm or greater than 1 micron. The particles can be index-matched to the polymer matrix to enable conversion of light to wavelengths optimized for absorption by specific photovoltaic materials. FIG. 10(a) shows scattering power of different Cabot particles with spherical morphology of particles approximately 4 microns in size. FIG. 10(d) shows a two-composition phosphor particle powder. FIGS. 10(e) and 10(f) show a surface-modified luminescent particle.

Particle synthesis approaches can be used in which either host lattices that contain multiple luminescent centers or composite particles comprising different materials are produced, such that a broad range of excitation wavelengths is achieved in a single particle. For example, FIG. 10(d) shows a composite powder wherein the particles comprise two different compositions.

Surface modified luminescent particles with both organic and/or inorganic coatings (see FIGS. 10(e) and 10(f)) can be used to both improve the gradient in refractive index between the luminescent particles and the fiber matrix, and to form a covalent bond between the luminescent particle and the fiber matrix to aid in the mechanical strength and homogeneity of the composite fiber structure.

The optical energy harvesting fibers described above act as fiber concentrators. Optical energy, such as sunlight, incident on the external surface of the fiber penetrates to the fiber core. Active elements in the core convert the incident wide-band illumination into one or more fixed wavelengths (e.g., by up-conversion, down-conversion, or both) to generate light that is trapped by the fiber and guided to its ends. The PBG structure described in relation to FIGS. 4 and 5 enables the fiber to be optically activated from nearly any angle while simultaneously capturing and guiding the emitted light. The problem of making the fiber transparent with respect to a wide range of wavelengths incident externally on the fiber while offering guidance to a prescribed wavelength is generally avoided via the PBG structure. This structure reflects incident light at any angle and polarization if the wavelength lies within its photonic bandgap, and hence provides omni-directional guidance to any wavelength lying deep within the photonic bandgap. This is important since light incident on the fiber and light generated by the active elements will potentially occupy a wide range of angles.

Because of the above-described functionality, the optical energy harvesting fibers act as flexible spectral band concentrators and provide maximal cost-effectiveness by minimizing the required photovoltaic surface. An added advantage is the fact that the active elements can be designed to absorb light over a wide range of wavelengths yet emit radiation at a narrow band of wavelengths, thus effectively concentrating the wide solar spectrum into a narrow spectral band. A great deal of the electromagnetic spectrum is outside the sensitivity range of existing solar cells. The fibers disclosed herein effectively compress this wide spectrum, currently untapped by other approaches, into a narrow spectral range for which the photovoltaic cell terminating the fiber is optimized.

The fiber technology disclosed herein has several unique aspects. The fibers are lightweight, robust, and flexible. The fibers need only a one-piece outer layer, in contradistinction to traditional fibers made of silica glass which need both an outer glass cladding and a plastic jacket. A transparent or translucent polymer cladding can also supply the protection from the environment.

Various optical design parameters of the optical energy harvesting fibers can be optimized. For example, a multilayer structure can be provided that simultaneously maximizes the transverse confinement of generated wavelengths and maximizes the transverse transmission of other wavelengths. In addition, a transverse index profile in the transparent cladding can be provided to maximize the focusing effect that is engendered by virtue of the cylindrical fiber structure. This enhances the intensity of the optical field reaching the active area and hence increases the optical conversion efficiency. Furthermore, the optical conversion efficiency and spectral compression of the active elements can be optimized as can be the photovoltaic cell terminating the fiber. Additionally, the scattering due to the active elements can be decreased and a stratified grating structure encapsulating the photonic bandgap fiber core can be provided to increase the optical coupling efficiency.

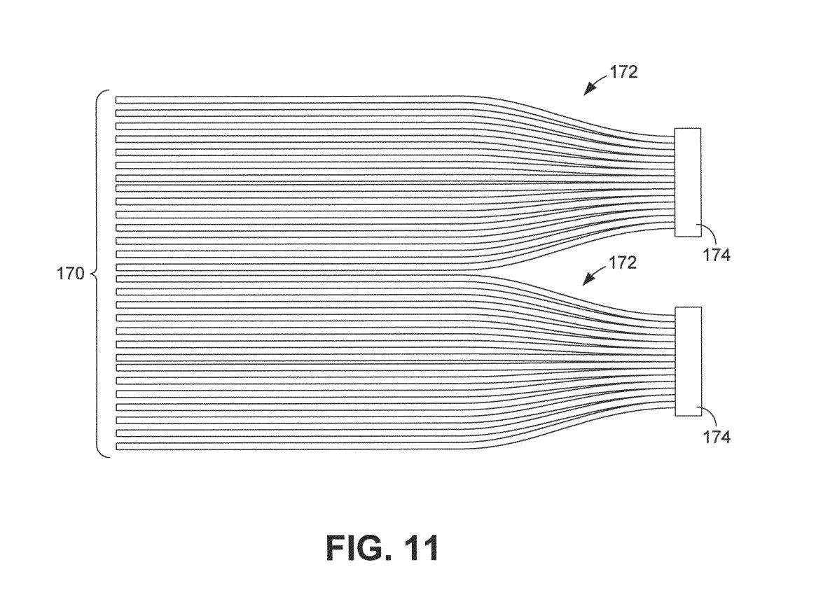

As described above, the disclosed optical energy harvesting fibers can be used to form, or can be incorporated into, fabrics. In such cases, the ends of the fibers that extend from the fabric can be bundled together into specific sizes. The number of fibers in each bundle will depend on the photovoltaic cell capacity because the amount of power collected per fiber will be within the optimal irradiance of the cell for optimal energy conversion. The bundles can be dipped into a glue compound with appropriate optical properties to adhere the fibers together. The glued fibers can then be placed into a mold that shapes the bundle to fit the photovoltaic cell connector assembly. After curing, the end of the fiber bundle can be cut and the end polished to optical quality. FIG. 11 illustrates multiple optical energy harvesting fibers 170, which can comprise part of a fabric, arranged into bundles 172 and connected to photovoltaic cell assemblies 174, which comprise or connect with photovoltaic cells.

The photovoltaic cell assembly 174 can comprise a small area, high-efficiency solar cell contained within a waterproof housing. In some embodiments, the housing is designed to accept the fiber bundle 172 and retain it to keep the fibers optically coupled to the solar cell and maintain proper fabric tension. Retention can be provided by twist lock or another method. For increased efficiency, refractive index matching liquids, gels, and/or antireflective coatings can be used in the assembly. Power conditioning electronics can also be incorporated into the assembly to provide proper power requirements.

The optical energy harvesting fibers can be used to form fabrics in various ways. For example, the fibers can be woven together to form a fabric or can be woven along with one or more other types of fibers or yarns. The fabrics can be incorporated into various objects, such as tents, sleeping bags, blankets, and the like that can be rolled up and handled without inconvenience. The fabric can collect optical (e.g., solar) radiation from large areas, and use much smaller area photovoltaic cells.

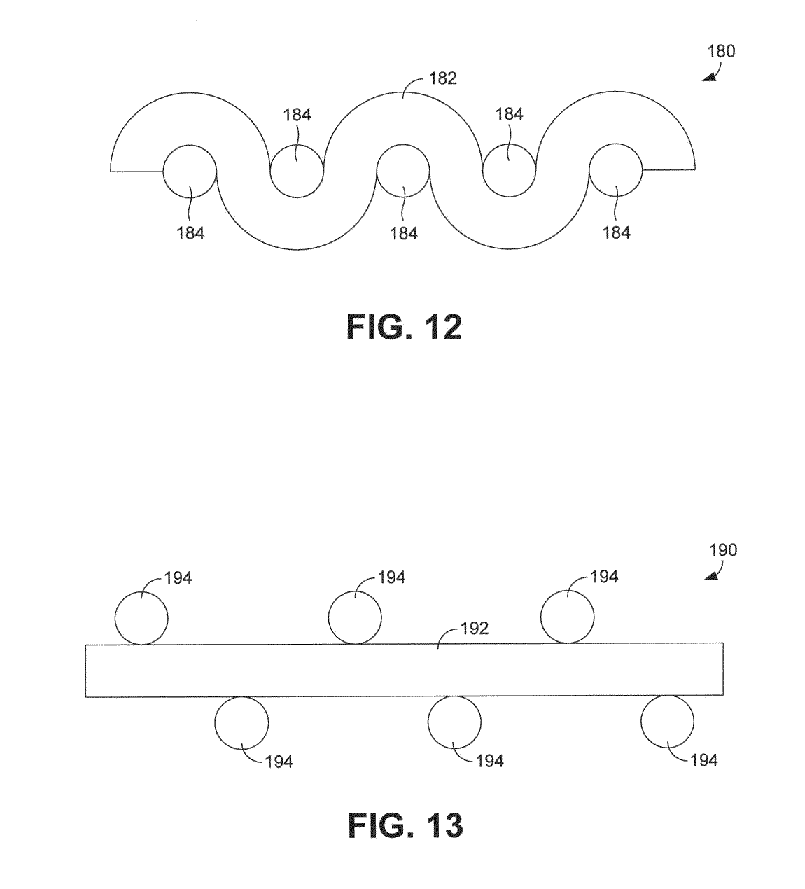

FIGS. 12 and 13 show example fabric embodiments. In FIG. 12, a plain weave fabric 180 is shown comprising warp fibers 182 and weft fibers 184. Either or both of the warp and weft fibers 182, 184 can be optical energy harvesting fibers. Moreover, within the warp and/or the weft, optical energy harvesting fibers can be alternated with other types of fibers or yarns in substantially any desired ratio (1:1, 2:1, etc.).

The amount of fiber crimp is determined by the tension on the fibers during the weaving process and fabric finishing. Crimp impacts the fabric modulus, flexibility, thickness, cover and the ability of the fabric to regain its form upon deformation. FIG. 13 shows a further plain weave fabric 190 comprising warp fibers 192 and weft fibers 194. In the fabric 190, however, the warp fibers 192 are tensioned and exhibit no crimp. The weft fibers 194 therefore bend around the warp fibers 192.

In addition to plain weaves, satin weaves, double cloth configurations, and other configurations can be used. Each of these configurations has a different degree of fabric cover and proportions of the warp/weft exposed to the surface. For example, plain weaves have maximal interlacing while satin weaves have long face floats, i.e., continuous lengths of the fiber before the fiber interlaces with the perpendicular fiber.

Other types of fibers or yarns can be used in the fabric to improve the performance of the final fabric system. For example, thermoset fibers that have a low bending modulus and elasticity can be included in the fabric. Once the fabric is constructed, it can be passed through a radiation heat chamber, which will cause the thermoset fibers to partially melt and set upon cooling, thereby securing the optical energy harvesting fibers. This results in a fabric that maintains its structure. In some embodiments, the fabric is designed to provide maximum exposure of the optical energy harvesting fibers to direct sunlight and has the highest possible density of optical fibers.

It is also possible to incorporate the optical energy harvesting fibers into a solid structure. This can be accomplished in a similar manner to traditional fiberglass, in which a woven fabric is impregnated with a resin and shaped to fit a desired form. The optical energy harvesting fibers can be woven into a fabric, and then the fabric can be coated with an optically transparent resin, plastic, or other suitable material. The fabric can then be molded into any shape that enables proper optical transmission in the fiber. In addition, the back of the molded piece can be provided with a reflective layer that causes non-coupled light to pass back through the fiber, possibly increasing the collection efficiency. The optical properties of the molded material can be custom tailored for the fibers used within the material. A solid molded solar collector could be used in many solar collection applications such as solar collecting body panels for hybrid or electric vehicles, window panels, skylights, and roof tiles.

The optical energy harvesting fibers and fabrics described herein provide a unique portable photovoltaic technology, with a dramatic enhancement in the implementation of electricity production via solar energy. This technology leverages the advanced capabilities of PBG fibers in conjunction with efficient up- and/or down-converting materials to concentrate the full solar spectrum to the narrow high-efficiency band of a small area solar cell. This approach is in contradistinction to the traditional approach of solar cell technology that focuses on expanding a semiconductor material's photosensitivity by creating increasingly complex, fragile, and low-yield device structures. By using the highest quantum efficiency frequency and wavelength, the requirement for complicated, expensive, strained super-lattice solar-cell structures can be avoided while enhancing the overall efficiency of the energy harvesting.

Although various embodiments have been described in this disclosure, those embodiments are only example implementations of the disclosed inventions. Alternative embodiments are possible and all such embodiments are intended to fall within the scope of this disclosure.

1. An optical energy harvesting fiber comprising:
a core comprising active elements that absorb light at one wavelength or range of wavelengths and emit light at one or more different wavelengths;
a guiding structure that guides the emitted light along a length of the fiber; and
a cladding that surrounds the core.

2. The fiber of claim 1, wherein the core is a solid core.

3. The fiber of claim 1, wherein the core is a hollow core.

4. The fiber of claim 1, wherein the active elements comprise one or more of fluorescent dyes, phosphorous dyes, nanoparticles, and quantum dots.

5. The fiber of claim 1, wherein the active elements down-convert light of a higher energy into light of a lower energy.

6. The fiber of claim 1, wherein the active elements up-convert light of a lower energy into light of a higher energy.

7. The fiber of claim 1, wherein the active elements absorb green light and emit red light.

8. The fiber of claim 1, wherein the guiding structure comprises the core which has a relatively high index of refraction and the cladding which has a relatively low index of refraction such that there is total internal reflection within the core.

9. The fiber of claim 1, wherein the guiding structure comprises a photonic bandgap structure that surrounds the core.

10. The fiber of claim 9, wherein the photonic bandgap structure comprises a plurality of pairs of layers having different indices of refraction.

11. The fiber of claim 9, wherein the photonic bandgap structure comprises a plurality of alternating glass and polymer layers.

12. The fiber of claim 1, wherein the cladding comprises features that concentrate incident light on the core.

13. The fiber of claim 12, wherein the features are lenslets that are formed in an outer surface of the cladding.

14. The fiber of claim 1, wherein the cladding comprises internal coupling gratings that guide incident light through the cladding and into the core.

15. A system for harvesting optical energy, the system comprising:
optical energy harvesting fibers having a core comprising active elements that absorb light at one wavelength of range of wavelengths and emit light at one or more different wavelengths, and a guiding structure that guides the emitted light along the lengths of the fibers; and
photovoltaic cells coupled to the optical energy harvesting fibers.

16. The system of claim 15, wherein the active elements comprise one or more of fluorescent dyes, phosphorous dyes, nanoparticles, and quantum dots.

17. The system of claim 15, wherein the guiding structure comprises the core which has a relatively high index of refraction and the cladding which has a relatively low index of refraction such that there is total internal reflection within the core.

18. The system of claim 15, wherein the guiding structure comprises a photonic bandgap structure that surrounds the core, the photonic bandgap structure comprising a plurality of pairs of layers having different indices of refraction.

19. The system of claim 15, wherein the cladding comprises lenslets formed in an outer surface of the cladding that concentrate incident light on the core.

20. The system of claim 15, wherein the photovoltaic cell is specifically optimized for the wavelengths of light emitted by the active elements.

21. A method for harvesting optical energy, the method comprising:
providing an optical energy harvesting fibers;
exposing the fibers to external incident light;
enabling the incident light to pass through a cladding of the fibers and into a core of the fibers;
absorbing the light and emitting light having a different wavelength; and
guiding the emitted light along the lengths of the fibers to photovoltaic cells.

22. The method of claim 21, wherein absorbing the light comprises absorbing the light with active elements provided within the core.

23. The method of claim 21, wherein guiding the emitted light comprises guiding the emitted light with a photonic bandgap structure that surrounds the core.

24. The method of claim 23, wherein the photonic bandgap structure and the photovoltaic cell are optimized for the wavelength or wavelengths of the emitted light.

25. A fabric comprising:
optical energy harvesting fibers having a core comprising active elements that absorb light at one wavelength of range of wavelengths and emit light at one or more different wavelengths, and a guiding structure that guides the emitted light along the lengths of the fibers.

26. The fabric of claim 25, wherein the active elements comprise one or more of fluorescent dyes, phosphorous dyes, nanoparticles, and quantum dots.

27. The fabric of claim 25, wherein the guiding structure comprises the core which has a relatively high index of refraction and the cladding which has a relatively low index of refraction such that there is total internal reflection within the core.

28. The fabric of claim 25, wherein the guiding structure comprises a photonic bandgap structure that surrounds the core, the photonic bandgap structure comprising a plurality of pairs of layers having different indices of refraction.

29. The fabric of claim 25, wherein the cladding comprises lenslets formed in an outer surface of the cladding that concentrate incident light on the core.
